(19) United States
(12) Patent Application Publication
(10) Pub. No.: US 2022/0407899 A1
(43) Pub. Date: Dec. 22, 2022

(54) REAL-TIME AUGMENTED REALITY COMMUNICATION SESSION

(71) Applicant: QUALCOMM Incorporated, San Diego, CA (US)

(72) Inventors: Imed Bouazizi, Frisco, TX (US); Thomas Stockhammer, Bergen (DE); Nikolai Konrad Leung, San Francisco, CA (US); Carlos Marcelo Dias Pazos, Carlsbad, CA (US); Liangping Ma, San Diego, CA (US)

(21) Appl. No.: 17/807,284

(22) Filed: Jun. 16, 2022

Related U.S. Application Data
(60) Provisional application No. 63/212,534, filed on Jun. 18, 2021.

(51) Int. Cl. H04L 65/401; H04L 65/1016; H04L 65/1069

(52) U.S. Cl. CPC H04L 65/401; H04L 65/1016; H04L 65/1069

(57) ABSTRACT

An example first client device for transmitting augmented reality (AR) media data includes a memory configured to store media data including voice data and augmented reality (AR) data; and one or more processors implemented in circuitry and configured to: participate in a voice call session with a second client device; receive data indicating that an AR session is to be initiated in addition to the voice call session from the second client device; receive data to initiate the AR session; and participate in the AR session with the second client device using the data to initiate the AR session.

This application claims the benefit of U.S. Provisional Application No. 63/212,534, filed Jun. 18, 2021, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The media data may be assembled into a media file conforming to any of a variety of standards, such as the International Organization for Standardization (ISO) base media file format and extensions thereof, such as AVC.

### SUMMARY

In general, this disclosure describes techniques for initiating an augmented reality (AR) session over an existing communication session, e.g., between two client devices. The existing communication session may be a voice call or a video call. That is, the client devices may exchange AR data during a real-time communication session. In particular, the client devices may begin by participating in a voice or video call. After initiating the voice or video call, one of the two client devices may initiate an AR session with the other client device. The client devices may then exchange AR data in addition or in the alternative to the original voice and/or video data of the existing communication session.

In one example, a method of transmitting augmented reality (AR) media data includes participating, by a first client device, in a voice call session with a second client device; receiving, by the first client device, data indicating that an augmented reality (AR) session is to be initiated in addition to the voice call session from the second client device; receiving, by the first client device, data to initiate the AR session; and participating, by the first client device, in the AR session with the second client device using the data to initiate the AR session.

In another example, a first client device for transmitting augmented reality (AR) media data includes a memory configured to store media data including voice data and augmented reality (AR) data; and one or more processors implemented in circuitry and configured to: participate in a voice call session with a second client device; receive data indicating that an AR session is to be initiated in addition to the voice call session from the second client device; receive data to initiate the AR session; and participate in the AR session with the second client device using the data to initiate the AR session.

In another example, a computer-readable storage medium has stored thereon instructions that, when executed, cause a processor of a first client device to: participate in a voice call session with a second client device; receive data indicating that an augmented reality (AR) session is to be initiated in addition to the voice call session from the second client device; receive data to initiate the AR session; and participate in the AR session with the second client device using the data to initiate the AR session.

In another example, a first client device for transmitting augmented reality (AR) media data includes means for participating in a two-dimensional (2D) multimedia communication session call with a second client device; means for receiving data indicating that the 2D multimedia communication session call is to be upgraded to an augmented reality (AR) session from the second client device; and means for participating in the AR session with the second client device after receiving a scene description for the AR session.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a conceptual diagram illustrating elements of example multimedia content.

FIG. 3 is a block diagram illustrating elements of an example video file.

FIG. 4 is a block diagram illustrating an example system that may be configured to perform the techniques of this disclosure.

FIG. 5 is a block diagram illustrating an example client device that may be configured to perform the techniques of this disclosure.

FIG. 6 is a call flow diagram illustrating an example method for setting up a communication session and upgrading the communication session to an AR application according to the techniques of this disclosure.

FIG. 7 is a flowchart illustrating an example method for adding an augmented reality (AR) session to an existing voice call and participating in the AR session and the voice call according to the techniques of this disclosure.

### DETAILED DESCRIPTION

In general, this disclosure describes techniques for initiating an augmented reality (AR) session over a multimedia communication session, e.g., between two client devices. That is, the client devices may exchange AR data during a real-time communication session. Although primarily described with respect to augmented reality, the techniques of this disclosure may also be directed to any combination of real world and/or virtual media data, e.g., extended reality (XR) or mixed reality (MR).

Various core use cases may have aspects related to real-time communication. Table 1 below summarizes examples of such use cases:

TABLE 1

| | |
|---|---|
| 3 | Real-time 3D Communication |
| 5 | Police Critical Mission with AR |
| 7 | Real-time communication with the shop assistant |
| 8 | 360-degree conference meeting |
| 9 | XR Meeting |
| 11 | AR animated avatar calls |
| 12 | AR avatar multi-party calls |
| 13 | Front-facing camera video multi-party calls |
| 16 | AR remote cooperation |
| 19 | AR Conferencing |

These use cases involve some form of real-time communication but follow different courses from application invocation to starting the AR experience. Some use cases start from a regular 2D communication, e.g., call or chat, and upgrade into an AR experience, others start as a full-fledged extended reality (XR) experience. The use cases may range from no real-time 3D asset exchange, i.e., only pre-stored 3D assets, to a heavy exchange of captured/reconstructed 3D assets in real-time. Thus, it is important to use procedures and call flows that are flexible enough to accommodate the different use cases.

The following design principles may be used to address needs of use cases that have real-time aspects. One design principle is to provide separate delivery functions from rendering functions. Such separation may ensure that the rendering functions operate independently of how the assets that are to be rendered are delivered, as long as the assets are available in time for rendering. Another design principle is to allow for flexible switching between AR and 2D experiences. That is, it should be possible to switch between an AR experience a 2D experience if desired by the application. The set of media components used for both experiences may or may not overlap. Yet another design principle is to provide for flexible addition and/or removal of objects and components. Another design principle is to provide support for both static and real-time, 2D and 3D components.

This disclosure recognizes the following three options for realizations of integrating multimedia telephony over IP Multimedia Subsystem (IMS) (MTSI) calls and AR experiences. A first option is that the full experience is offered through a single application, namely the MTSI application. The MTSI application may be enhanced to support the AR experience. All session control and media may be exchanged through the IMS core. The advantage of this first option is that the application is self-contained and will receive support from the IMS core. However, the disadvantages are that it is much less flexible as it restricts application innovation compared to over-the-top (OTT) applications, requires operator support/endorsement, and requires significant extensions to the MTSI specification.

A second option is that the MTSI client is embedded and used as a library in the AR application. The starting point would thus always be the AR application, which establishes the IMS call on a need basis. The advantage of this second option is that the IMS client is limited to the transport of the IMS-based media. All rendering would then be controlled by the AR application. The AR application may invoke other transport channels to exchange the necessary media for the AR experience. This requires that the MTSI client is available to application developers as a library component. It also requires the MTSI client to relinquish control over the processed IMS media to the AR application for compositing and rendering.

A third option is that the MTSI client and the AR application are two separate, standalone applications. The MTSI client may trigger the AR application to provide an AR experience. The AR application may terminate to fallback to a regular MTSI call. The advantage of this third option is that minimal to no changes to the MTSI application would be required. The AR application may be responsible for rendering all AR-related media, and the MTSI client may be limited to rendering speech only. The AR application may leverage over the top content and transport mechanisms, such as WebRTC, without impacting the IMS core. A possible variation of this third option would allow the AR application to take control of the output of the MTSI application for compositing and rendering.

This disclosure describes detailed examples based on the third option for enabling AR in conversational and interactive scenarios.

In HTTP streaming, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

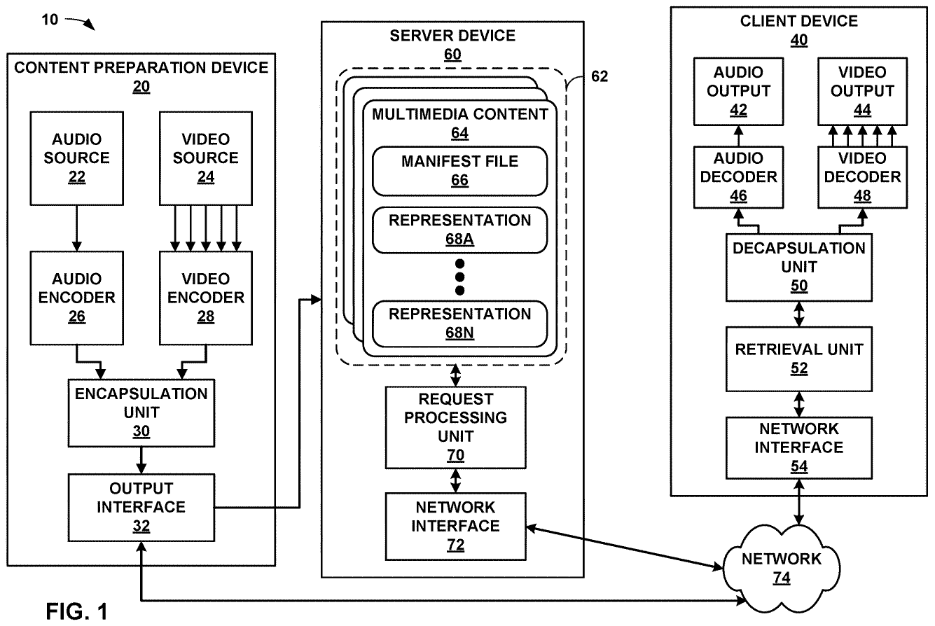

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC, the High Efficiency Video Coding (HEVC) standard, or the Versatile Video Coding (VVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a MPD that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

In some examples, content preparation device 20 and server device 60 may prepare and send augmented reality (AR) content to client device 40. Client device 40 may cache the AR content and use the AR content during a real-time communication session with another client device, as discussed in greater detail below.

In some examples, content preparation device 20 and/or server device 60 may also be configured as client devices. That is, two client devices may include the elements of each of content preparation device 20, server device 60, and client device 40 and thereby be configured to both capture, encode and transmit data, as well as receive, decode, and present data. According to the techniques of this disclosure, two or more users may use respective client devices to engage in a voice call or video call, and then add an AR session to the ongoing voice or video call. In general, this disclosure refers to any communication session including voice data as a “voice call.” Thus, a voice call may include a video call that also includes exchange of voice data.

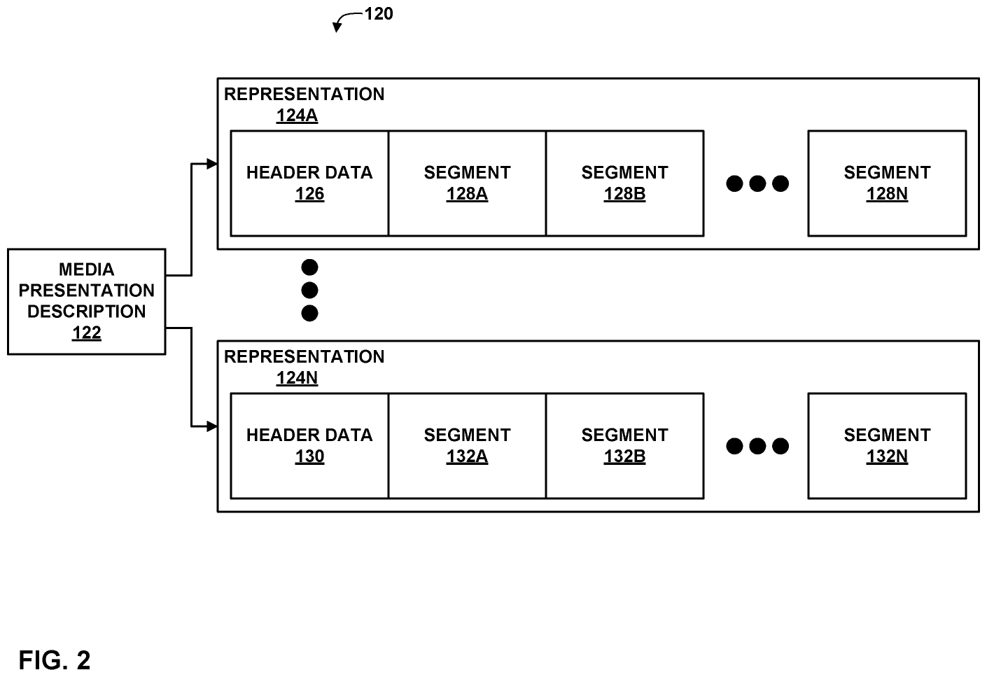

FIG. 2 is a conceptual diagram illustrating elements of example multimedia content 120. Multimedia content 120 may correspond to multimedia content 64 (FIG. 1), or another multimedia content stored in storage medium 62. In the example of FIG. 2, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to manifest file 66 of FIG. 1. Likewise, representations 124 may correspond to representations 68 of FIG. 1. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 2. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

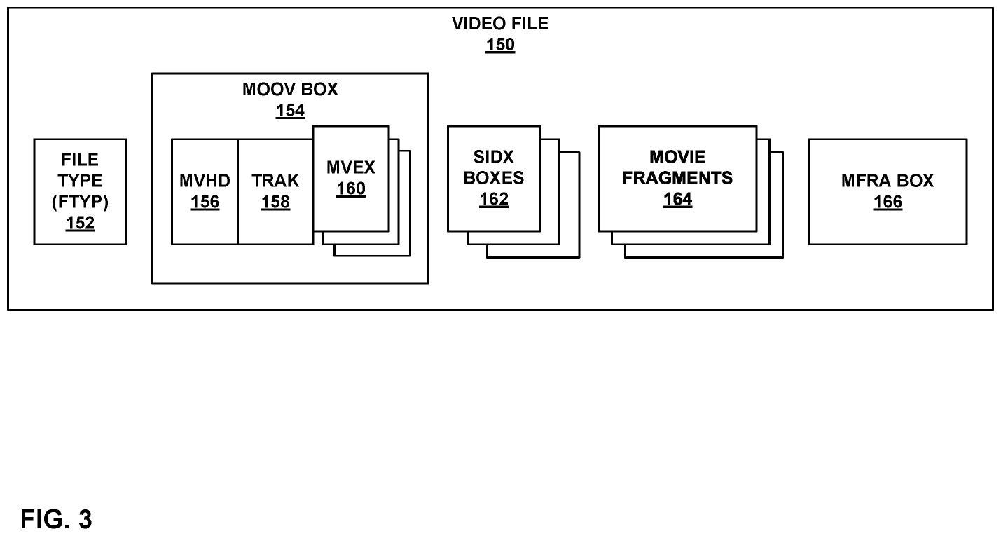

FIG. 3 is a block diagram illustrating elements of an example video file 150, which may correspond to a segment of a representation, such as one of segments 128, 132 of FIG. 2. Each of segments 128, 132 may include data that conforms substantially to the arrangement of data illustrated in the example of FIG. 3. Video file 150 may be said to encapsulate a segment. As described above, video files in accordance with the ISO base media file format and extensions thereof store data in a series of objects, referred to as “boxes.” In the example of FIG. 3, video file 150 includes file type (FTYP) box 152, movie (MOOV) box 154, segment index (sidx) boxes 162, movie fragment (MOOF) boxes 164, and movie fragment random access (MFRA) box 166. Although FIG. 3 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150.

MOOV box 154, in the example of FIG. 3, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 2) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 3). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

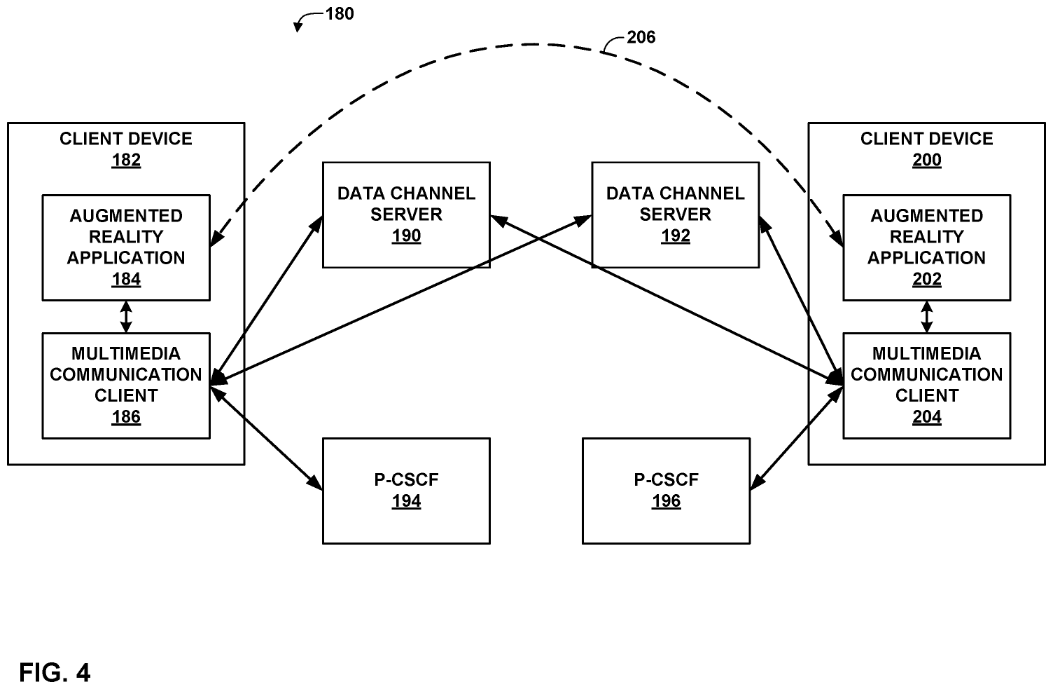

FIG. 4 is a block diagram illustrating an example system 180 that may be configured to perform the techniques of this disclosure. System 180 includes client device 182, client device 200, data channel server 190, data channel server 192, proxy call session control function (P-CSCF) device 194, and P-CSCF device 196. Client device 182 includes augmented reality (AR) application 184 and multimedia communication client 186. Client device 200 includes augmented reality application 202 and multimedia communication client 204. Multimedia communication clients 186, 204 may operate according to conventional voice telephony and/or multimedia telephony over IP Multimedia Subsystem (IMS) (MTSI). In general, multimedia communication clients 186, 204 may cause augmented reality applications 184, 202, respectively, to participate in augmented reality session 126.

In general, client devices 182, 200 may initially participate in a voice call, such as an MTSI call. At some point, without loss of generality, client device 182 (for example) may request to initiate AR session 206. Client device 182 may send the request to initiate AR session 206 to DCS 192. DCS 192 may provide trigger data to initiate AR session 206 to client device 200. Thus, client device 200 may receive data from DCS 192 indicating that AR session 206 is to be added to the voice call. Client device 200 may further receive data to initiate AR session 206, such as a scene description. After initiating AR session 206, client device 182 and client device 200 may participate in AR session 206 along with participating in the original voice call, e.g., MTSI call.

To enable the launch of the augmented reality (AR) application from a regular call (e.g., a voice call or an MTSI call between multimedia communication clients 186, 204), multimedia communication clients 186, 204 may perform a bootstrap procedure. In this bootstrap procedure, multimedia communication clients 186, 204 may receive a trigger with the entry point or a URL to the entry point for the corresponding one of AR applications 184, 202. Multimedia communication clients 186, 204 may pass the entry point or URL to the entry point to the respective one of AR applications 184, 202. This allows scenarios where the application starts with a regular call and then, for example, based on an action from one of the participants or from an application server, triggers the upgrade to add AR session 206.

Calls that are eligible for upgrade to AR session 206 may be required to establish a control connection, over which they will send and receive triggers for starting AR session 206. This channel may be an IMS data channel that is offered by a data channel server (DCS), e.g., one of data channel servers 190, 192. DCSs 190, 192 may trigger the upgrade to the AR application by themselves or based on input from one of the remote participants (e.g., users of client devices 182, 200).

The trigger may contain an entry point for the AR application, which may be in the form of a scene description. The scene description, or a URL to the scene description, may be provided using a supported sub-protocol.

Data channel servers 190, 192 may be local data channel servers or remote data channel servers.

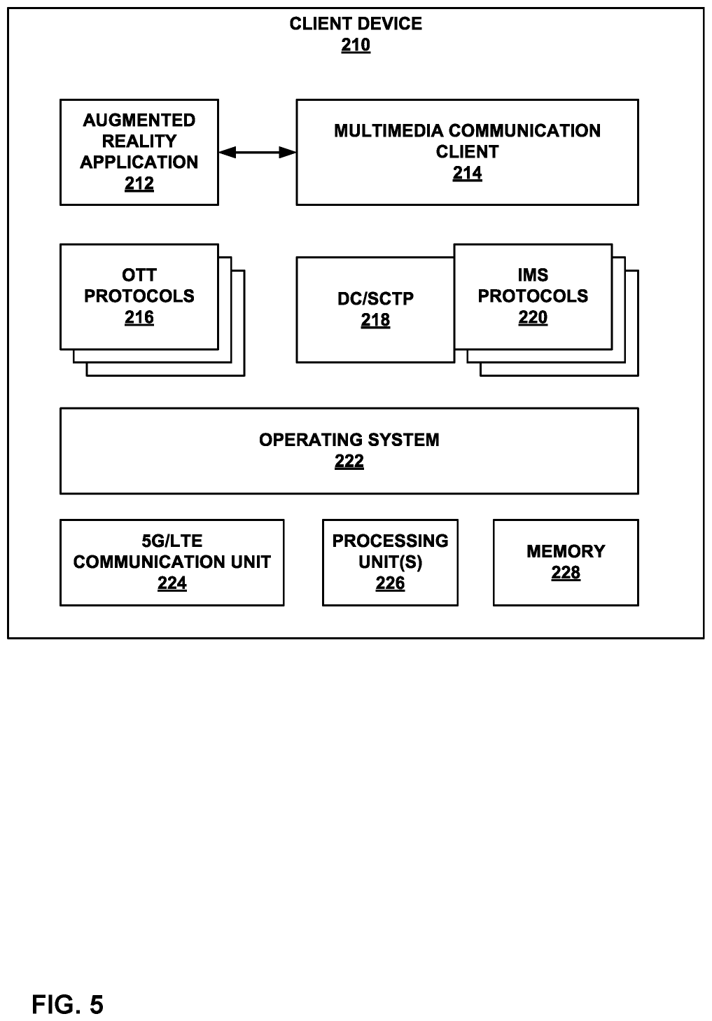

FIG. 5 is a block diagram illustrating an example client device 210 that may be configured to perform the techniques of this disclosure. Client device 210 in this example includes 5G/LTE communication unit 224, processing unit(s) 226, and memory 228. Processing unit(s) 226 may include one or more processing units implemented in circuitry, such as one or more microprocessors, digital signal processors (DSPs), application specific integrated circuits (ASICs), field programmable gate arrays (FPGAs), discrete logic circuitry, or combinations thereof.

Memory 228 may store retrieved media data (e.g., AR data) and instructions for various applications executed by processing units 226. Memory 228 may store instructions for operating system 222, augmented reality application 212, multimedia communication client 214, over-the-top (OTT) protocols 216, DC/SCTP 218, and IMS protocols 220. OTT protocols 216 may include, for example, WebRTC, HTTP, and the like. IMS protocols 220 may include, for example, session initiation protocol (SIP), real-time transport protocol (RTP), RTP control protocol (RTCP), or the like.

Operating system 222 may provide an application execution environment in which the various other applications shown in FIG. 5 may be executed by processing unit(s) 226. Augmented reality application 212 may be executed over OTT protocols 216. That is, AR data for augmented reality application 212 may be exchanged via OTT protocols 216. Similarly, multimedia communication client 214 may be executed over DC/SCTP 218 and IMS protocols 220. Communication data sent and received by multimedia communication client 214 may be exchanged via DC/SCTP 218 and IMS protocols 220. In some examples, multimedia communication client 214 may be an MTSI application. In this manner, FIG. 5 depicts application stacks for AR applications executed by client device 210.

Client device 210 may also be referred to as user equipment or “UE.” Client devices 182, 200 of FIG. 4 may include components that are the same as or similar to those of client device 210. Similarly, client device 40 of FIG. 1 may include components that are the same as or similar to those of client device 210.

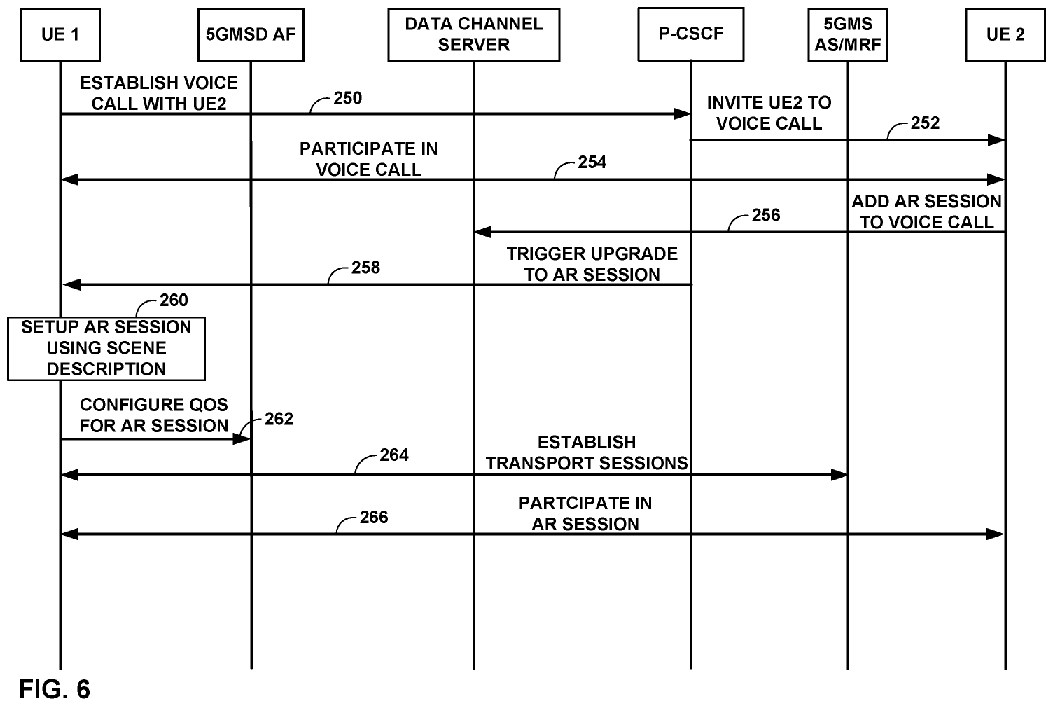

FIG. 6 is a call flow diagram illustrating an example method for setting up a communication session and upgrading the communication session to an AR application according to the techniques of this disclosure. The method of FIG. 6 is explained with respect to client device 210 of FIG. 5. However, other devices, such as client device 40 of FIG. 1 or client devices 182, 200 of FIG. 4 may be configured to perform this or a similar method as well.

Initially, multimedia communication client 214 (representing an example of an MTSI client) of client device 210 (which may also be referred to as a first UE device or “UE1” as shown in FIG. 6) may initiate a voice call or multimedia communication session with a second client device (“UE2” as shown in FIG. 6) (250). This initiation may include establishing a call with the second client device via a P-CSCF device (e.g., one of P-CSCF devices 194, 196), the P-CSCF device inviting the second client device to join the call (252), and establishing the call. UE1 may then participate in a voice call with UE2 (254). The voice call may be a voice only call or a multimedia call including video data in addition to voice data.

At some point during the voice call, the second client device (UE2) may send data to a data channel server (e.g., one of data channel servers 190, 192 of FIG. 4) indicating the intent to upgrade the call to an AR experience (256). The data channel server may send data triggering an upgrade to the AR experience to multimedia communication client 214 of UE1 (258). The data triggering the upgrade to the AR session may include a scene description as an entry point. Multimedia communication client 214 of UE1 may send the scene description as the entry point to augmented reality application 212 thereof. Augmented reality application 212 may then setup an AR scene using the scene description (260).

Client device 210 may then set up over-the-top (OTT) media streams. In particular, an AR scene manager of UE1 may parse the scene description and configure the media streams with a mobility management entity (MIME) application function (MAF) of client device 210. The MAF of client device 210 may then configure a quality of service (QoS) for AR session 206 with a 5G media downlink streaming application function (5GMSd AF) (262). The MAF of client device 210 and a 5G media streaming application server (5GMS AS/MRF) may then establish one or more transport sessions (264). The MAF of client device 210 may further configure media pipelines, e.g., buffers and decoders for buffering received data and decoding the received data.

Client device 210 (UE1) may then participate in an AR session with UE2 (266). For example, client device 210 may fetch and render media data during the AR session. For example, the MAF of client device 210 may receive immersive media data (e.g., AR data) from the 5GMS AS/MRF. Client device 210 may then decode and process the AR media data and pass the AR media data to the AR/MR scene manager. Likewise, multimedia communication client 214 may also pass decoded media data (e.g., 2D media data exchanged via MTSI) to the AR/MR scene manager. The AR/MR scene manager may compose and render final images from the decoded AR media data and the 2D media data and pass these images to a display for presentation to a user.

In this manner, the method of FIG. 6 represents an example of a method of transmitting augmented reality (AR) media data, the method including participating, by a first client device, in a voice call session with a second client device; receiving, by the first client device, data indicating that an augmented reality (AR) session is to be initiated in addition to the voice call session from the second client device; receiving, by the first client device, data to initiate the AR session; and participating, by the first client device, in the AR session with the second client device using the data to initiate the AR session.

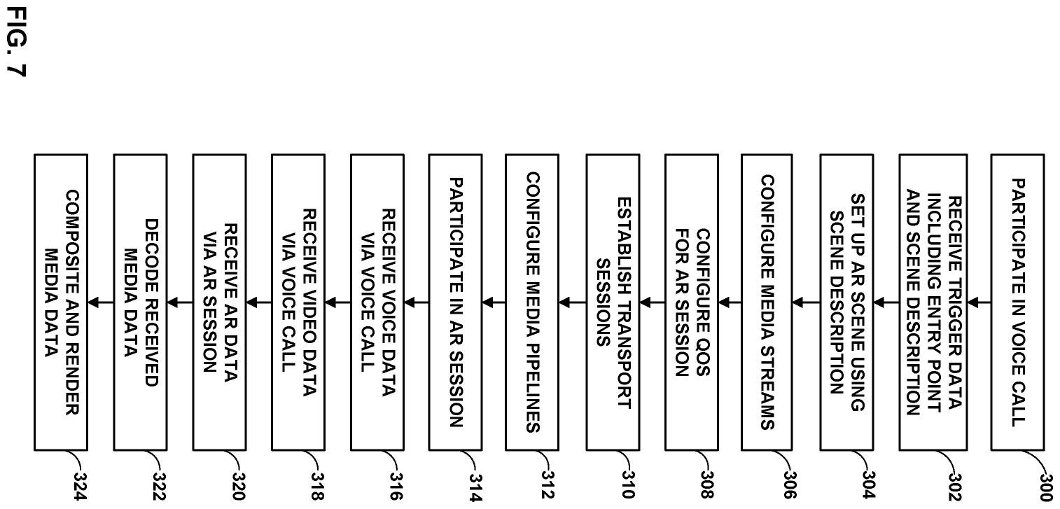

FIG. 7 is a flowchart illustrating an example method for adding an augmented reality (AR) session to an existing voice call and participating in the AR session and the voice call according to the techniques of this disclosure. The method of FIG. 7 is explained with respect to client device 210 of FIG. 5 for purposes of example and explanation. However, client device 40 of FIG. 1 and client devices 182, 200 of FIG. 4 may also be configured to perform the method of FIG. 7.

Initially, client device 210 may participate in a voice call (300). The voice call may be a multimedia call, e.g., a video call, or a voice call only. Initially, multimedia communication client 214 (e.g., an MTSI client) may establish the voice call with a second client device, e.g., via a proxy call session control function (P-CSCF) device. Client device 210 may send and receive voice (and in some cases, video) data with the second client device via the voice call.

At some point, client device 210 may receive trigger data, which may include an entry point and scene description (302). The scene description may describe an AR scene as a hierarchical structure, which may be represented in the form of a graph including vertices and edges. The vertices (nodes) of the graph may represent various types of objects, such as audio, image, video, graphics, or text objects. Certain vertices may have child vertices, connected by edges, that describe parameters of the parent vertices. Some vertices may represent sensors, for detecting interaction by users to trigger other actions, such as animations and movement through the AR scene. Client device 210 may set up the AR scene using the scene description (304). For example, AR application 212 may present AR objects at appropriate locations in the AR scene as indicated by the scene description.

Client device 210 may further configure media streams for the AR session (306). For example, an AR scene manager may configure the media streams with one or more media access functions (MAFs) of client device 210. The MAFs may then configure quality of service (QoS) for the AR session (308) with a 5G media downlink streaming application function (5GMSd AF). The MAFs of client device 210 may then establish one or more transport sessions with a 5GMS application server (AS) (310), and configure media pipelines (312). To configure the media pipelines, client device 210 may instantiate buffers for receiving media data for the various transport sessions, as well as decoders to decode the received media data.

Client device 210 may then participate in the AR session (314) with the second client device, e.g., in conjunction with the existing voice call. Thus, client device 210 may receive voice data via the voice call (316), receive video data via the voice call (318), and receive AR data via the AR session (320). The AR data may include data representing movement of a user of the second client device in the AR scene, as well as whether any of the virtual objects in the AR scene are triggered by interaction with the user, e.g., due to the user's movement.

The various decoders of client device 310 may decode the received media data (322), e.g., the video, voice, and AR data. Client device 310 may then composite and render the media data as part of the AR scene (324), such that a user of client device 310 may perceive all of the corresponding media data together.

In this manner, the method of FIG. 7 represents an example of a method of transmitting augmented reality (AR) media data, the method including participating, by a first client device, in a voice call session with a second client device; receiving, by the first client device, data indicating that an augmented reality (AR) session is to be initiated in addition to the voice call session from the second client device; receiving, by the first client device, data to initiate the AR session; and participating, by the first client device, in the AR session with the second client device using the data to initiate the AR session.

Certain examples of the techniques of this disclosure are summarized in the following clauses:

Clause 1: A method of transmitting augmented reality (AR) media data, the method comprising: participating, by a multimedia communication client of a first client device, in a two-dimensional (2D) multimedia communication session call with a second client device; receiving, by the multimedia communication client, data indicating that the 2D multimedia communication session call is to be upgraded to an augmented reality (AR) session from the second client device; passing, by the multimedia communication client, a scene description for the AR session to an augmented reality client of the first client device; and participating, by the augmented reality client, in the AR session with the second client device.

Clause 2: The method of clause 1, wherein participating in the AR session includes: receiving 2D media data of the multimedia communication session call from the second client device; receiving AR data of the AR session from the second client device; and rendering an image using the 2D media data and the AR data.

Clause 3: The method of any of clauses 1 and 2, wherein receiving the data indicating that the 2D multimedia communication session call is to be upgraded to the AR session comprises receiving trigger data from a data channel server.

Clause 4: The method of any of clauses 1-3, wherein the multimedia communication session call comprises a multimedia telephony over IP Multimedia Subsystem (IMS) (MTSI) call.

Clause 5: A device for transmitting augmented reality (AR) media data, the device comprising one or more means for performing the method of any of clauses 1-4.

Clause 6: The device of clause 5, wherein the one or more means comprise one or more processors implemented in circuitry.

Clause 7: The apparatus of clause 5, wherein the apparatus comprises at least one of: an integrated circuit; a microprocessor; and a wireless communication device.

Clause 8: A first client device for transmitting augmented reality (AR) media data, the first client device comprising: means for participating in a two-dimensional (2D) multimedia communication session call with a second client device; means for receiving data indicating that the 2D multimedia communication session call is to be upgraded to an augmented reality (AR) session from the second client device; and means for participating in the AR session with the second client device after receiving a scene description for the AR session.

Clause 9: A method of transmitting augmented reality (AR) media data, the method comprising: participating, by a first client device, in a voice call session with a second client device; receiving, by the first client device, data indicating that an augmented reality (AR) session is to be initiated in addition to the voice call session from the second client device; receiving, by the first client device, data to initiate the AR session; and participating, by the first client device, in the AR session with the second client device using the data to initiate the AR session.

Clause 10: The method of clause 9, wherein participating in the AR session comprises participating in the AR session with the second client device while participating in the voice call session with the second client device.

Clause 11: The method of clause 9, wherein participating in the AR session includes: receiving voice data of the voice call session from the second client device; receiving AR data of the AR session from the second client device; and presenting the voice data together with the AR data.

Clause 12: The method of clause 9, wherein receiving the data indicating that the AR session is to be initiated comprises receiving trigger data from a data channel server device.

Clause 13: The method of clause 9, wherein receiving the data indicating that the AR session is to be initiated comprises receiving a scene description for the AR session.

Clause 14: The method of clause 9, further comprising initiating the AR session, including: configuring one or more media streams for the AR session; configuring quality of service (QoS) for the AR session; and establishing transport sessions for the AR session.

Clause 15: The method of clause 9, wherein the voice call session comprises a multimedia telephony over IP Multimedia Subsystem (IMS) (MTSI) call.

Clause 16: The method of clause 9, wherein the voice call session comprises a video and voice session, the method further comprising: receiving video data via the video and voice session; receiving AR data via the AR session; and rendering the video data with AR data.

Clause 17: The method of clause 9, wherein participating in the voice call session comprises sending and receiving voice data via a first communication session with the second client device, and wherein participating in the AR session comprises sending and receiving voice data via a second communication session with the second client device.

Clause 18: A first client device for transmitting augmented reality (AR) media data, the first client device comprising: a memory configured to store media data including voice data and augmented reality (AR) data; and one or more processors implemented in circuitry and configured to: participate in a voice call session with a second client device; receive data indicating that an AR session is to be initiated in addition to the voice call session from the second client device; receive data to initiate the AR session; and participate in the AR session with the second client device using the data to initiate the AR session.

Clause 19: The device of clause 18, wherein the one or more processors are configured to participate in the AR session with the second client device while participating in the voice call session with the second client device.

Clause 20: The device of clause 18, wherein to participate in the AR session, the one or more processors are configured to: receive voice data of the voice call session from the second client device; receive AR data of the AR session from the second client device; and present the voice data together with the AR data.

Clause 21: The device of clause 18, wherein to receive the data indicating that the AR session is to be initiated, the one or more processors are configured to receive trigger data from a data channel server device.

Clause 22: The device of clause 18, wherein to receive the data indicating that the AR session is to be initiated, the one or more processors are configured to receive a scene description for the AR session.

Clause 23: The device of clause 18, wherein the one or more processors are further configured to initiate the AR session, including: configure one or more media streams for the AR session; configure quality of service (QoS) for the AR session; and establish transport sessions for the AR session.

Clause 24: The device of clause 18, wherein the voice call session comprises a multimedia telephony over IP Multimedia Subsystem (IMS) (MTSI) call.

Clause 25: The device of clause 18, wherein the voice call session comprises a video and voice session, and wherein the one or more processors are further configured to: receive video data via the video and voice session; receive AR data via the AR session; and render the video data with AR data.

Clause 26: The device of clause 18, wherein to participate in the voice call session, the one or more processors are configured to send and receive voice data via a first communication session with the second client device, and wherein to participate in the AR session, the one or more processors are configured to send and receive voice data via a second communication session with the second client device.

Clause 27: The device of clause 18, wherein the device comprises at least one of: an integrated circuit; a microprocessor; or a wireless communication device.

Clause 28: A computer-readable storage medium having stored thereon instructions that, when executed, cause a processor of a first client device to: participate in a voice call session with a second client device; receive data indicating that an augmented reality (AR) session is to be initiated in addition to the voice call session from the second client device; receive data to initiate the AR session; and participate in the AR session with the second client device using the data to initiate the AR session.

Clause 29: The computer-readable storage medium of clause 28, wherein the instructions that cause the processor to participate in the AR session comprise instructions that cause the processor to participate in the AR session with the second client device while participating in the voice call session with the second client device.

Clause 30: The computer-readable storage medium of clause 28, wherein the instructions that cause the processor to participate in the AR session include instructions that cause the processor to: receive voice data of the voice call session from the second client device; receive AR data of the AR session from the second client device; and present the voice data together with the AR data.

Clause 31: The computer-readable storage medium of clause 28, wherein the instructions that cause the processor to receive the data indicating that the AR session is to be initiated comprise instructions that cause the processor to receive trigger data from a data channel server device.

Clause 32: The computer-readable storage medium of clause 28, wherein the instructions that cause the processor to receive the data indicating that the AR session is to be initiated comprise instructions that cause the processor to receive a scene description for the AR session.

Clause 33: The computer-readable storage medium of clause 28, further comprising instructions that cause the processor to initiate the AR session, including instructions that cause the processor to: configure one or more media streams for the AR session; configure quality of service (QoS) for the AR session; and establish transport sessions for the AR session.

Clause 34: The computer-readable storage medium of clause 28, wherein the voice call session comprises a multimedia telephony over IP Multimedia Subsystem (IMS) (MTSI) call.

Clause 35: The computer-readable storage medium of clause 28, wherein the voice call session comprises a video and voice session, further comprising instructions that cause the processor to: receive video data via the video and voice session; receive AR data via the AR session; and render the video data with AR data.

Clause 36: The computer-readable storage medium of clause 28, wherein the instructions that cause the processor to participate in the voice call session comprise instructions that cause the processor to send and receive voice data via a first communication session with the second client device, and wherein the instructions that cause the processor to participate in the AR session comprise instructions that cause the processor to send and receive voice data via a second communication session with the second client device.

Clause 37: A first client device for transmitting augmented reality (AR) media data, the first client device comprising: means for participating in a two-dimensional (2D) multimedia communication session call with a second client device; means for receiving data indicating that the 2D multimedia communication session call is to be upgraded to an augmented reality (AR) session from the second client device; and means for participating in the AR session with the second client device after receiving a scene description for the AR session.

Clause 38: A method of transmitting augmented reality (AR) media data, the method comprising: participating, by a first client device, in a voice call session with a second client device; receiving, by the first client device, data indicating that an augmented reality (AR) session is to be initiated in addition to the voice call session from the second client device; receiving, by the first client device, data to initiate the AR session; and participating, by the first client device, in the AR session with the second client device using the data to initiate the AR session.

Clause 39: The method of clause 38, wherein participating in the AR session comprises participating in the AR session with the second client device while participating in the voice call session with the second client device.

Clause 40: The method of any of clauses 38 and 39, wherein participating in the AR session includes: receiving voice data of the voice call session from the second client device; receiving AR data of the AR session from the second client device; and presenting the voice data together with the AR data.

Clause 41: The method of any of clauses 38-40, wherein receiving the data indicating that the AR session is to be initiated comprises receiving trigger data from a data channel server device.

Clause 42: The method of any of clauses 38-41, wherein receiving the data indicating that the AR session is to be initiated comprises receiving a scene description for the AR session.

Clause 43: The method of any of clauses 38-42, further comprising initiating the AR session, including: configuring one or more media streams for the AR session; configuring quality of service (QoS) for the AR session; and establishing transport sessions for the AR session.

Clause 44: The method of any of clauses 38-43, wherein the voice call session comprises a multimedia telephony over IP Multimedia Subsystem (IMS) (MTSI) call.

Clause 45: The method of any of clauses 38-44, wherein the voice call session comprises a video and voice session, the method further comprising: receiving video data via the video and voice session; receiving AR data via the AR session; and rendering the video data with AR data.

Clause 46: The method of any of clauses 38-45, wherein participating in the voice call session comprises sending and receiving voice data via a first communication session with the second client device, and wherein participating in the AR session comprises sending and receiving voice data via a second communication session with the second client device.

Clause 47: A first client device for transmitting augmented reality (AR) media data, the first client device comprising: a memory configured to store media data including voice data and augmented reality (AR) data; and one or more processors implemented in circuitry and configured to: participate in a voice call session with a second client device; receive data indicating that an AR session is to be initiated in addition to the voice call session from the second client device; receive data to initiate the AR session; and participate in the AR session with the second client device using the data to initiate the AR session.

Clause 48: The device of clause 47, wherein the one or more processors are configured to participate in the AR session with the second client device while participating in the voice call session with the second client device.

Clause 49: The device of any of clauses 47 and 48, wherein to participate in the AR session, the one or more processors are configured to: receive voice data of the voice call session from the second client device; receive AR data of the AR session from the second client device; and present the voice data together with the AR data.

Clause 50: The device of any of clauses 47-49, wherein to receive the data indicating that the AR session is to be initiated, the one or more processors are configured to receive trigger data from a data channel server device.

Clause 51: The device of any of clauses 47-50, wherein to receive the data indicating that the AR session is to be initiated, the one or more processors are configured to receive a scene description for the AR session.

Clause 52: The device of any of clauses 47-51, wherein the one or more processors are further configured to initiate the AR session, including: configure one or more media streams for the AR session; configure quality of service (QoS) for the AR session; and establish transport sessions for the AR session.

Clause 53: The device of any of clauses 47-52, wherein the voice call session comprises a multimedia telephony over IP Multimedia Subsystem (IMS) (MTSI) call.

Clause 54: The device of any of clauses 47-53, wherein the voice call session comprises a video and voice session, and wherein the one or more processors are further configured to: receive video data via the video and voice session; receive AR data via the AR session; and render the video data with AR data.

Clause 55: The device of any of clauses 47-54, wherein to participate in the voice call session, the one or more processors are configured to send and receive voice data via a first communication session with the second client device, and wherein to participate in the AR session, the one or more processors are configured to send and receive voice data via a second communication session with the second client device.

Clause 56: The device of any of clauses 47-55, wherein the device comprises at least one of: an integrated circuit; a microprocessor; or a wireless communication device.

Clause 57: A computer-readable storage medium having stored thereon instructions that, when executed, cause a processor of a first client device to: participate in a voice call session with a second client device; receive data indicating that an augmented reality (AR) session is to be initiated in addition to the voice call session from the second client device; receive data to initiate the AR session; and participate in the AR session with the second client device using the data to initiate the AR session.

Clause 58: The computer-readable storage medium of clause 57, wherein the instructions that cause the processor to participate in the AR session comprise instructions that cause the processor to participate in the AR session with the second client device while participating in the voice call session with the second client device.

Clause 59: The computer-readable storage medium of any of clauses 57 and 58, wherein the instructions that cause the processor to participate in the AR session include instructions that cause the processor to: receive voice data of the voice call session from the second client device; receive AR data of the AR session from the second client device; and present the voice data together with the AR data.

Clause 60: The computer-readable storage medium of any of clauses 57-59, wherein the instructions that cause the processor to receive the data indicating that the AR session is to be initiated comprise instructions that cause the processor to receive trigger data from a data channel server device.

Clause 61: The computer-readable storage medium of any of clauses 57-60, wherein the instructions that cause the processor to receive the data indicating that the AR session is to be initiated comprise instructions that cause the processor to receive a scene description for the AR session.

Clause 62: The computer-readable storage medium of any of clauses 57-61, further comprising instructions that cause the processor to initiate the AR session, including instructions that cause the processor to: configure one or more media streams for the AR session; configure quality of service (QoS) for the AR session; and establish transport sessions for the AR session.

Clause 63: The computer-readable storage medium of any of clauses 57-62, wherein the voice call session comprises a multimedia telephony over IP Multimedia Subsystem (IMS) (MTSI) call.

Clause 64: The computer-readable storage medium of any of clauses 57-63, wherein the voice call session comprises a video and voice session, further comprising instructions that cause the processor to: receive video data via the video and voice session; receive AR data via the AR session; and render the video data with AR data.

Clause 65: The computer-readable storage medium of any of clauses 57-64, wherein the instructions that cause the processor to participate in the voice call session comprise instructions that cause the processor to send and receive voice data via a first communication session with the second client device, and wherein the instructions that cause the processor to participate in the AR session comprise instructions that cause the processor to send and receive voice data via a second communication session with the second client device.

Clause 66: A first client device for transmitting augmented reality (AR) media data, the first client device comprising: means for participating in a two-dimensional (2D) multimedia communication session call with a second client device; means for receiving data indicating that the 2D multimedia communication session call is to be upgraded to an augmented reality (AR) session from the second client device; and means for participating in the AR session with the second client device after receiving a scene description for the AR session.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of transmitting augmented reality (AR) media data, the method comprising:
participating, by a client device, in a voice call session;
receiving, by the client device, data indicating that an augmented reality (AR) session is to be initiated in addition to the voice call session;
receiving, by the client device, data to initiate the AR session; and
participating, by the client device, in the AR session using the data to initiate the AR session.

2. The method of claim 1, wherein participating in the AR session comprises participating in the AR session while participating in the voice call session.

3. The method of claim 1, wherein participating in the AR session includes:
receiving voice data of the voice call session;
receiving AR data of the AR session; and
presenting the voice data together with the AR data.

4. The method of claim 1, wherein receiving the data indicating that the AR session is to be initiated comprises receiving trigger data from a data channel server device.

5. The method of claim 1, wherein receiving the data indicating that the AR session is to be initiated comprises receiving a scene description for the AR session.

6. The method of claim 1, further comprising initiating the AR session, including:
configuring one or more media streams for the AR session;
configuring quality of service (QoS) for the AR session; and
establishing transport sessions for the AR session.

7. The method of claim 1, wherein the voice call session comprises a multimedia telephony over IP Multimedia Subsystem (IMS) (MTSI) call.

8. The method of claim 1, wherein the voice call session comprises a video and voice session, the method further comprising:
receiving video data via the video and voice session;
receiving AR data via the AR session; and
rendering the video data with AR data.

9. The method of claim 1,
wherein participating in the voice call session comprises sending and receiving voice data via a first communication session, and
wherein participating in the AR session comprises sending and receiving voice data via a second communication session.

10. A client device for transmitting augmented reality (AR) media data, the client device comprising:
a memory configured to store media data including voice data and augmented reality (AR) data; and
one or more processors implemented in circuitry and configured to:
participate in a voice call session;
receive data indicating that an AR session is to be initiated in addition to the voice call session;
receive data to initiate the AR session; and
participate in the AR session using the data to initiate the AR session.

11. The device of claim 10, wherein the one or more processors are configured to participate in the AR session while participating in the voice call session.

12. The device of claim 10, wherein to participate in the AR session, the one or more processors are configured to:
receive voice data of the voice call session;
receive AR data of the AR session; and
present the voice data together with the AR data.

13. The device of claim 10, wherein to receive the data indicating that the AR session is to be initiated, the one or more processors are configured to receive trigger data from a data channel server device.

14. The device of claim 10, wherein to receive the data indicating that the AR session is to be initiated, the one or more processors are configured to receive a scene description for the AR session.

15. The device of claim 10, wherein the one or more processors are further configured to initiate the AR session, including:
configure one or more media streams for the AR session;
configure quality of service (QoS) for the AR session; and
establish transport sessions for the AR session.

16. The device of claim 10, wherein the voice call session comprises a multimedia telephony over IP Multimedia Subsystem (IMS) (MTSI) call.

17. The device of claim 10, wherein the voice call session comprises a video and voice session, and wherein the one or more processors are further configured to:
receive video data via the video and voice session;
receive AR data via the AR session; and
render the video data with AR data.

18. The device of claim 10,
wherein to participate in the voice call session, the one or more processors are configured to send and receive voice data via a first communication session, and
wherein to participate in the AR session, the one or more processors are configured to send and receive voice data via a second communication session.

19. The device of claim 10, wherein the device comprises at least one of:
an integrated circuit;
a microprocessor; or
a wireless communication device.

20. A computer-readable storage medium having stored thereon instructions that, when executed, cause a processor of a client device to:
participate in a voice call session;
receive data indicating that an augmented reality (AR) session is to be initiated in addition to the voice call session;
receive data to initiate the AR session; and
participate in the AR session using the data to initiate the AR session.

21. The computer-readable storage medium of claim 20, wherein the instructions that cause the processor to participate in the AR session comprise instructions that cause the processor to participate in the AR session while participating in the voice call session.

22. The computer-readable storage medium of claim 20, wherein the instructions that cause the processor to participate in the AR session include instructions that cause the processor to:
receive voice data of the voice call session;
receive AR data of the AR session; and
present the voice data together with the AR data.

23. The computer-readable storage medium of claim 20, wherein the instructions that cause the processor to receive the data indicating that the AR session is to be initiated comprise instructions that cause the processor to receive trigger data from a data channel server device.

24. The computer-readable storage medium of claim 20, wherein the instructions that cause the processor to receive the data indicating that the AR session is to be initiated comprise instructions that cause the processor to receive a scene description for the AR session.

25. The computer-readable storage medium of claim 20, further comprising instructions that cause the processor to initiate the AR session, including instructions that cause the processor to:
configure one or more media streams for the AR session;
configure quality of service (QoS) for the AR session; and
establish transport sessions for the AR session.

26. The computer-readable storage medium of claim 20, wherein the voice call session comprises a multimedia telephony over IP Multimedia Subsystem (IMS) (MTSI) call.

27. The computer-readable storage medium of claim 20, wherein the voice call session comprises a video and voice session, further comprising instructions that cause the processor to:
receive video data via the video and voice session;
receive AR data via the AR session; and
render the video data with AR data.

28. The computer-readable storage medium of claim 20,
wherein the instructions that cause the processor to participate in the voice call session comprise instructions that cause the processor to send and receive voice data via a first communication session, and
wherein the instructions that cause the processor to participate in the AR session comprise instructions that cause the processor to send and receive voice data via a second communication session.

29. A client device for transmitting augmented reality (AR) media data, the client device comprising:
means for participating in a two-dimensional (2D) multimedia communication session call;
means for receiving data indicating that the 2D multimedia communication session call is to be upgraded to an augmented reality (AR) session; and
means for participating in the AR session after receiving a scene description for the AR session.
